(19) United States
(12) Patent Application Publication
(10) Pub. No.: US 2020/0380103 A1
(43) Pub. Date: Dec. 3, 2020

(54) APPARATUS, METHOD, AND STORAGE MEDIUM

(71) Applicant: CANON KABUSHIKI KAISHA, Tokyo (JP)

(72) Inventor: Yasuhiro Hosoda, Kawasaki-shi (JP)

(21) Appl. No.: 16/885,037

(22) Filed: May 27, 2020

(30) Foreign Application Priority Data
May 31, 2019 (JP) 2019-102880

(51) Int. Cl. G06F 21/32; G06K 9/00; G06K 9/62; G06F 3/0482

(52) U.S. Cl. CPC G06F 21/32; G06K 9/00275; G06F 3/0482; G06K 9/6215; G06K 9/00295

(57) ABSTRACT

In a case where at least two login functions of a face authentication login function and a simple login function are enabled in an apparatus, the apparatus performs login processing based on a face authentication result indicating that a condition for allowing a user to log in to the apparatus is satisfied and displays a screen after login, and the apparatus displays a button corresponding to each of one or more candidates obtained from the face authentication result on a login screen based on the face authentication result indicating that the condition for allowing the user to log in to the apparatus is not satisfied, performs login processing upon selection of a button, and displays a screen after login.

### BACKGROUND OF THE INVENTION

### Field of the Invention

The aspect of the embodiments relates to an apparatus including a face authentication login function, a method, and a storage medium.

### Description of the Related Art

An information processing apparatus including a face authentication login function is known (see Japanese Patent Application Laid-Open No. 2015-35178). In addition, an information processing apparatus that provides a simple login function in which buttons respectively corresponding to a plurality of users are displayed on a screen and a user presses a button corresponding to the user is known (see Japanese Patent Application Laid-Open No. 2015-227048).

### SUMMARY OF THE INVENTION

According to an aspect of the embodiments, an apparatus provides a face authentication login function and a simple login function. The face authentication login function allows a user identified by face authentication based on face data acquired by capturing an image of the user with a camera to log in to the apparatus. The simple login function allows the user identified based on a button selected from among buttons corresponding to a plurality of users displayed on a login screen to log in to the apparatus. The apparatus includes a setting unit configured to receive a setting for enabling at least two login functions of the face authentication login function and the simple login function. In a case where the at least two login functions of the face authentication login function and the simple login function are enabled in the apparatus, the apparatus performs login processing based on a face authentication result indicating that a condition for allowing the user to log in to the apparatus is satisfied and displays a screen after login, and the apparatus displays a button corresponding to each of one or more candidates obtained from the face authentication result on the login screen based on the face authentication result indicating that the condition for allowing the user to log in to the apparatus is not satisfied, performs the login processing upon selection of a button, and displays the screen after login.

Further features of the disclosure will become apparent from the following description of exemplary embodiments with reference to the attached drawings.

### BRIEF DESCRIPTION OF THE DRAWINGS

FIG. 1 is a diagram illustrating a system configuration.

FIG. 2 is a block diagram illustrating a hardware configuration of a multifunction peripheral (MFP).

FIG. 3 is a block diagram illustrating a software configuration of each of the MFP and a face authentication server in the system.

FIGS. 4A and 4B are diagrams illustrating user interfaces to be displayed on an operation unit of the MFP.

FIG. 5 is a flowchart illustrating face authentication processing.

FIGS. 6A and 6B are diagrams illustrating simple login screens after face authentication.

FIG. 7 is a diagram illustrating a captured image when a plurality of faces is detected.

### DESCRIPTION OF THE EMBODIMENTS

There is an issue that a login by using face authentication is not successful all of the time. In some cases, the face authentication fails, and in other cases, the number of candidates for the user who is attempting to log in cannot be narrowed down to one as a result of the face authentication, thereby the user cannot log in. To deal with this issue, it is possible to use the face authentication login function together with a login function in which buttons corresponding to a plurality of users are displayed on a screen and each user is prompted to select a button corresponding to the user to allow the user to log in (referred to as a simple login function). However, use of the two login functions in combination alone is not appropriate because it takes time and effort for each user to search for the button corresponding to the user.

The aspect of the embodiments is directed to providing two login functions, i.e., a face authentication login function and a simple login function, and enabling a user to log in to an information processing apparatus without any confusion, thereby improving user-friendliness.

Exemplary embodiments of the disclosure will be described below with reference to the accompanying drawings.

### <System Configuration>

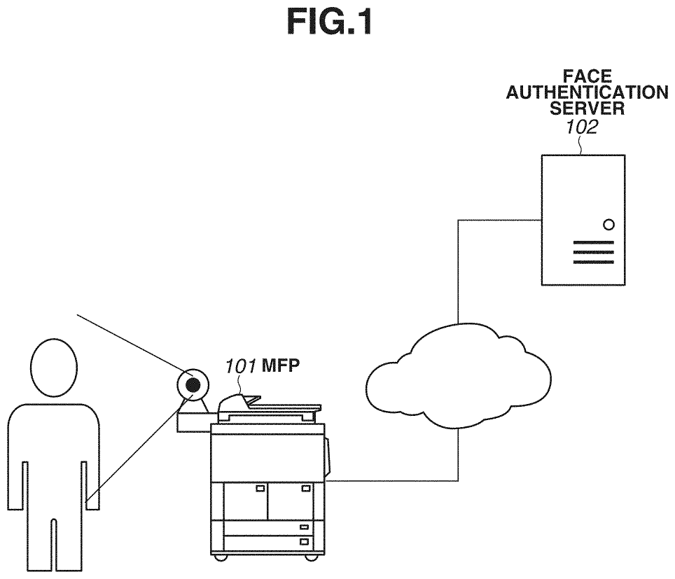

FIG. 1 is a diagram illustrating a configuration of a system including an image forming apparatus to which the aspect of the embodiments is applied. A multifunction peripheral (MFP) 101 is an example of the information processing apparatus to which the aspect of the embodiments is applied. The MFP 101 uses a camera unit to capture an image of a user who approaches the MFP 101, and performs face authentication. If a result of face authentication satisfies a specific condition for allowing the user to log in, the MFP 101 allows the user to automatically log in. If the result of face authentication does not satisfy the condition for allowing the user to automatically log in, the MFP 101 provides the user with the simple login function using the result of face authentication as an alternative login function.

A face authentication server 102 is a face authentication server that receives face data, performs face authentication, and returns an authentication result (i.e., an identifier and a score of a candidate). The face data is data on a captured face image, or data obtained by extracting a feature amount of a face from a face image using an existing technique. The MFP 101 and the face authentication server 102 are connected via a local area network (LAN) or the Internet. In the present exemplary embodiment, the face authentication server 102 is a service built as a virtual server on a cloud service. However, as the face authentication server 102, a server set on an intranet may be used, or a face authentication function incorporated in the MFP 101 may also be used. The term face authentication login function refers to a function for performing face authentication to allow a user to log in. The face authentication login function is also referred to simply as a face authentication function.

### <Hardware Configuration of MFP>

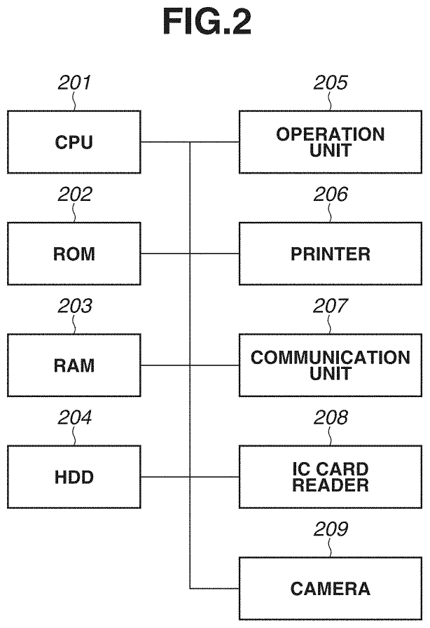

FIG. 2 is a block diagram simply illustrating the hardware configuration of the MFP 101. A central processing unit (CPU) 201 is a processor that controls operation of the entire MFP 101. A random access memory (RAM) 203 is a volatile memory and is used as a temporary storage area for loading various control programs stored in a read-only memory (ROM) 202 and a hard disk drive (HDD) 204.

The ROM 202 is a nonvolatile memory, and stores a boot program for the MFP 101. The HDD 204 is a nonvolatile hard disk having a capacity larger than that of the RAM 203. The HDD 204 stores control programs for the MFP 101. The HDD 204 also stores an operating system (OS) and an application program.

When the MFP 101 is started up, the CPU 201 executes the boot program stored in the ROM 202. The boot program is used to read out a program for the OS stored in the HDD 204 and to load the program into the RAM 203. After executing the boot program, the CPU 201 executes the program for the OS loaded into the RAM 203, thereby controlling the MFP 101. Further, the CPU 201 also stores data used for operation by the control programs in the RAM 203, and reads and writes the data.

In the MFP 101, the single CPU 201 executes each process illustrated in a flowchart to be described below, but the MFP 101 may have another configuration instead. For example, each process illustrated in the flowchart to be described below may be cooperatively executed by a plurality of CPUs or microprocessors (MPUs). Alternatively, a part of the processing to be described below may be executed by a hardware circuit such as an application specific integrated circuit (ASIC) or a field-programmable gate array (FPGA).

An operation unit 205 is a display on which a touch operation can be performed. Various user interfaces to be described below are displayed on the operation unit 205. A printer 206 is a printer engine for printing print data received from an external apparatus via a communication unit 207. The communication unit 207 is a network interface for connecting the information processing apparatus to the Internet or a LAN in an office.

An integrated circuit (IC) card reader 208 is a unit for reading out information to be used for user authentication from an IC card and is a unit used to implement IC card authentication. A camera 209 is a camera unit for capturing an image of the face of the user who uses the MFP 101. The camera 209 can be an external camera connectable to the information processing apparatus via a universal serial bus (USB) or a wireless LAN.

### <Software Configuration>

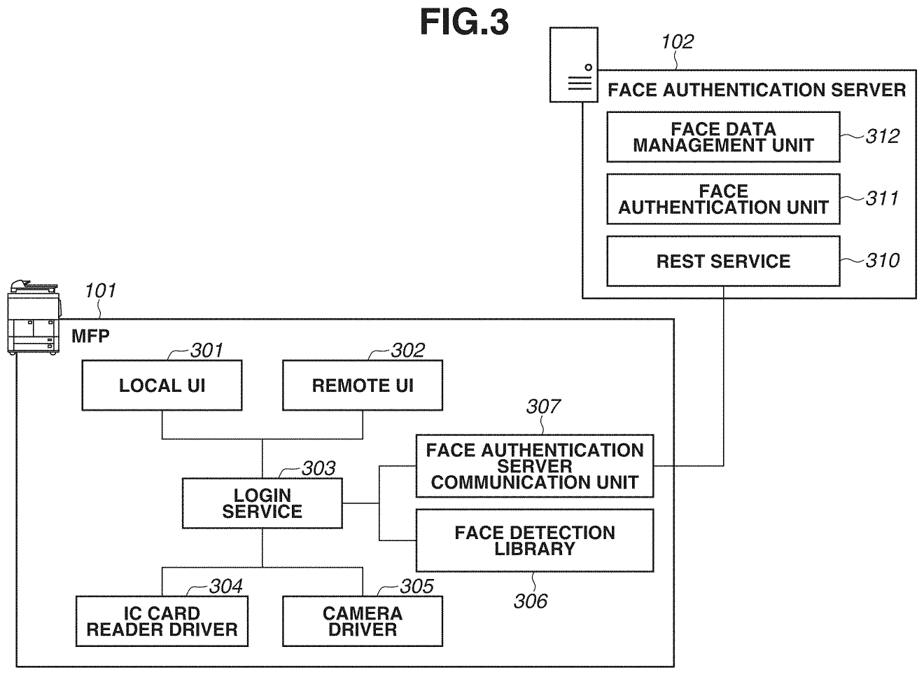

FIG. 3 is a block diagram simply illustrating a software configuration of each of the MFP 101 and the face authentication server 102.

### <Software Configuration of Face Authentication Server>

The software configuration of the face authentication server 102 will be described. A Representational State Transfer (REST) service 310 is a service that receives a face data registration request and a face authentication request from a terminal (including the MFP 101) connected via the Internet using REST. For example, the REST service 310 receives face data and a user name using REST and registers the received face data and user name in association with each other in a face data management unit 312. At this time, a personal identification (ID) is issued as a unique ID for identifying each user, and the personal ID is notified to the terminal that has transmitted the request. For example, the face data management unit 312 manages face data on a plurality of users as illustrated in Table 1.

TABLE 1

| Personal ID | User Name | Face Data |
|---|---|---|
| 96df7500-7e82 . . . | Alice | ******** |
| 6fc11e17-faf4 . . . | Carol | ******** |
| 1fb233f6-1f8e . . . | Dave | ******** |

If the REST service 310 receives face data together with the face authentication request, a face authentication unit 311 refers to data on registered users illustrated in Table 1, and obtains candidates and calculates a score for each of the candidates. The score represents, in percentage, a value indicating possibility of the candidate being the user calculated based on the received face data. Instead of representing the score in percentage, the score may be represented by the magnitude of the value of a natural number. In some cases, the calculation result can indicate that the number of candidates is zero. In other cases, a plurality of candidates can be identified for face data on a single person and the score for each of the identified candidates can be calculated. If a plurality of pieces of face data is included in the received face data, a plurality of candidates is obtained and the score for each of the candidates is calculated. The calculation result is returned to the terminal via the REST service 310.

The cloud service as described above is generally referred to as a cognitive service. An example of the service for providing the face authentication function is FaceAPI® provided by Microsoft Corporation. For example, FaceAPI® provides REST services for receiving requests as illustrated in Table 2.

TABLE 2

| Request | | | |
|---|---|---|---|
| Type | Functions | Input Data | Output Data |
| Create | Register user | User name | Personal ID |
| | information | and the like | ID for registered |
| | | | user |
| Add Face | Designate personal ID | Face image | Face ID |
| | and register face image | | ID for registered |
| | | | face image |
| Detect | Detect face from image | Image | Face ID |
| | | | ID for detected |
| | | | face image |
| Identify | Designate face ID and | Face ID | Personal ID and |
| | acquire face | | score for candidate |
| | authentication result | | |
| Get | Designate personal ID | Personal ID | User name and the |
| | and acquire user name | | like |
| | and the like | | |

The MFP 101 cooperates with the cognitive service as described above to provide the user with the face authentication login function.

### <Software Configuration of MFP>

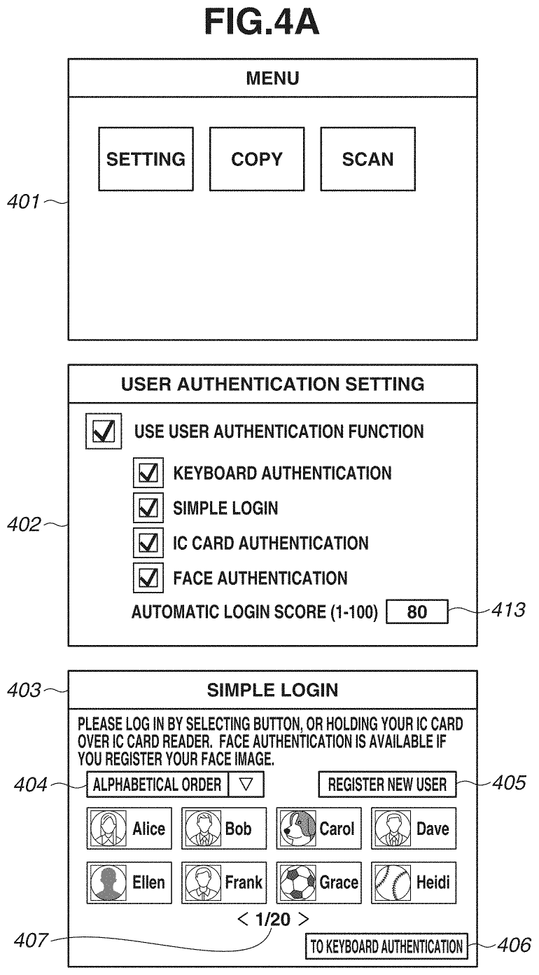

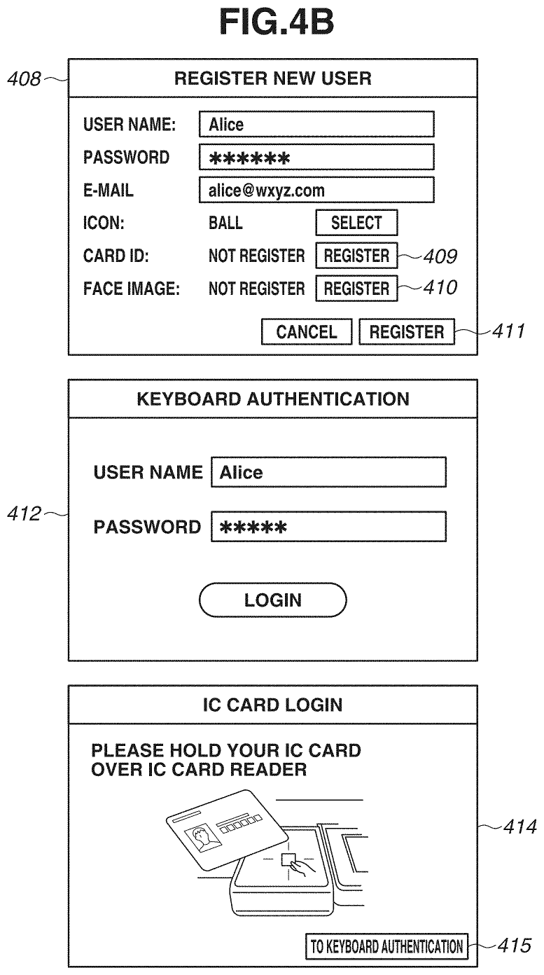

The software configuration of the MFP 101 will be described. A local user interface (UI) 301 of the MFP 101 provides a user interface for the user to change settings of the MFP 101 and use functions of the MFP 101 on the display of the operation unit 205. FIGS. 4A and 4B illustrate examples of the user interface provided by the local UI 301. A remote UI 302 includes a Hypertext Transfer Protocol (HTTP) server function, and provides the user with a user interface composed of a HyperText Markup Language (HTML). The user can access the remote UI 302 using a web browser of a user terminal and can change the settings of the MFP 101 and use functions of the MFP 101. A login service 303 is a software module for authenticating the user who uses the local UI 301 or the remote UI 302 and logging the authenticated user in to the MFP 101. In the login service 303, accounts of an administrator and a general user can be registered in the HDD 204 via a user interface such as the local UI 301 or the remote UI 302. Table 3 illustrates an example of account information stored in the HDD 204. As the account information, a user name, a password, a card ID of an IC card, a role (administrator/general user), an e-mail address, and the like can be registered in the HDD 204. In addition, a blank personal ID field indicates that face authentication is not registered for the user.

TABLE 3

| User | | | | | |
|---|---|---|---|---|---|
| Name | Password | Card ID | Role | Mail | Personal ID |
| Admin | ***** | ABC123456 | Administrator | admin@wxyz.com | |
| Alice | ***** | ABC123457 | General user | alice@wxyz.com | 96df7500- |
| | | | | | 7e82 . . . |
| Bob | ***** | ABC123458 | General user | bob@wxyz.com | |
| Carol | ***** | ABC123459 | General user | carol@wxyz.com | 6fc11e17- |
| | | | | | faf4 . . . |
| Dave | ***** | ABC123460 | General user | dave@wxyz.com | 1fb233f6- |
| | | | | | 1f8e . . . |

The user authentication function is disabled in the factory default setting of the MFP 101. Upon start-up of the MFP 101, the local UI 301 displays a menu screen 401 for selecting an application. The term “user authentication function” used herein does not exactly indicate the user authentication function because the simple login function identifies each user and allows the identified user to log in without performing user authentication. However, the use of the term “user authentication function” enables the user of the MFP 101 to easily understand the function. Accordingly, the term “user authentication function” is used in the present exemplary embodiment. The user authentication function that can be selected from a user authentication setting screen 402 can also be referred to as a login function.

The user can display the user authentication setting screen 402 via the menu screen 401. Enabling/disabling the user authentication function can be selected on the user authentication setting screen 402. When enabling the user authentication function is selected, one or more login functions can be selected from among a keyboard authentication function, the simple login function, an IC card authentication function, and a face authentication function. The user authentication setting screen 402 represents a state where the user authentication function is enabled and all login functions are selected.

When the face authentication function is enabled, a threshold for a score for allowing the user to automatically log in to the MFP 101 by face authentication can be input and set in a text box 413. For example, a value ranging from 1 to 100 is set as the score. Instead of asking the user to input the value, options such as “large”, “medium”, and “small” can be presented to the user to select one from the options, or the value can be set by a UI part such as a slide bar. The setting selected by the user is stored in the HDD 204, and the login service 303 refers to the setting and starts the login function corresponding to the setting selected by the user.

If all the login functions (keyboard authentication function, simple login function, IC card authentication function, and face authentication function) are enabled, the local UI 301 displays a simple login screen 403. The user can still perform the IC card authentication by holding his/her IC card over the IC card reader 208 while the simple login screen 403 is displayed, and the user can still perform the keyboard authentication by selecting a button 406 to cause the screen to transition to a keyboard authentication screen 412. In other words, if the simple login function is set as the login function, the local UI 301 displays the simple login screen 403 even if other login functions are enabled. If the simple login function is not set and only the keyboard authentication is enabled, the keyboard authentication screen 412 is displayed. If only the IC card authentication is enabled or both the IC card authentication and the keyboard authentication are enabled, an IC card authentication screen 414 is displayed. The IC card authentication screen 414 provides a button 415 for displaying the keyboard authentication screen 412.

The login service 303 does not allow operation of enabling only the face authentication function as the login function. If the user sets the face authentication function from the user authentication setting screen 402, the local UI 301 controls the screen so that at least one of the three authentication functions other than the face authentication function is set. The simple login screen 403 displays buttons respectively corresponding to registered users. Each user is to select a button corresponding to the user, so that the user is logged in to the MFP 101. At this time, processing of referring to the user ID corresponding to the selected button is carried out, and so-called authentication processing for verifying authentication information is not carried out. More specifically, there is no need for the user to input authentication information via an IC card or a keyboard.

If the number of buttons respectively corresponding to registered users is too large to display all the buttons on one screen, the buttons are displayed over a plurality of pages. A button 407 indicates a page number of a currently displayed page, and is used for page transition. The simple login screen 403 includes a button sorting function. A dropdown 404 is used to select an order of sorting the buttons. As the order of sorting the buttons, for example, an alphabetical order, a descending order of registration, and a descending order of last login time can be selected.

A new user registration button 405 is used to register an account of a general user. Upon detecting that the new user registration button 405 is pressed, the local UI 301 displays a user registration screen 408. The user registration screen 408 receives input information, such as a user name, a password, and an e-mail address of a newly registered user. The simple login screen 403 provides a function for selecting an icon to be displayed with the button corresponding to the user. If it is detected that a card ID registration button 409 is pressed, the IC card reader 208 is operated to enable data on the IC card to be read via an IC card reader driver 304. When the IC card is held over the IC card reader 208, the card ID is acquired.

If it is detected that a face image registration button 410 is pressed, the camera 209 is operated via a camera driver 305 to capture an image of the user who is in front of the MFP 101. Further, face detection processing is performed on the acquired image by using a face detection library 306 to check whether a face image is included in the image. Open source OpenCV is generally known as an example of a library having functions, such as an image processing function, an image analysis function, and a machine learning function. As the face detection library 306, any open source library as described above may be used. There is no need to register a card ID or a face image on the user registration screen 408, and the card ID or the face image may be left unregistered.

If it is detected that a registration button 411 is pressed, the acquired information is registered in the HDD 204 as account information (Table 3). If an image including a face image is acquired by pressing the face image registration button 410, a request for registering face data is transmitted to the REST service 310 of the face authentication server 102 via a face authentication server communication unit 307. In this case, the face data is transmitted as needed in a format (such as an image file or a value obtained by calculating only the feature amount of a face) supported by the face authentication server 102. The login service 303 receives a personal ID as a response to the request for registering face data, and registers the personal ID in the HDD 204 as account information (Table 3).

The login service 303 can determine whether the user has a face image already registered based on presence of the personal ID in the account information (Table 3). A face image file or information indicating whether the face image is already registered may be recorded in association with the account information stored in the HDD 204. As for registration of the account information, a function for collectively registering account information on a plurality of users may be provided (using the local UI 301 or the remote UI 302 as a UI for the administrator of the MFP 101). The card ID and the face image used by the administrator to collectively register the account information may be data acquired from an apparatus other than the IC card reader 208 and the camera 209 of the MFP 101.

Upon detecting an IC card, the login service 303 refers to the account information stored in the HDD 204 and allows the user corresponding to the card ID to log in to the MFP 101. Upon detecting that the button 406 for displaying a keyboard authentication screen is pressed, the keyboard authentication screen 412 is displayed to receive the input of the user name and the password. The login service 303 compares the user name and the password input on the keyboard authentication screen 412 with the account information stored in the HDD 204, and allows the user corresponding to the user name and the password to log in to the MFP 101.

The login service 303 stores an object called a login context as information about the login user, and transmits the object to another software module. An example of information to be stored as the login context is illustrated in Table 4. As illustrated in Table 4, the user name, role, and e-mail address of the login user are stored as the login context.

TABLE 4

| Item | Value |
|---|---|
| Login user name | Alice |
| Role | General user |
| E-mail | alice@wxyz.com |

If the login to the MFP 101 is successful, the local UI 301 closes the login screen such as the simple login screen 403, and causes the screen to transition to the menu screen 401. As the menu screen 401, a menu screen for the login user is provided after the login user is identified by referring to the login context described above. The menu screen and screens for various functions (e.g., copy, scan) provide a function for personalizing the screens based on user's preferences.

### <Face Authentication Operation Flow>

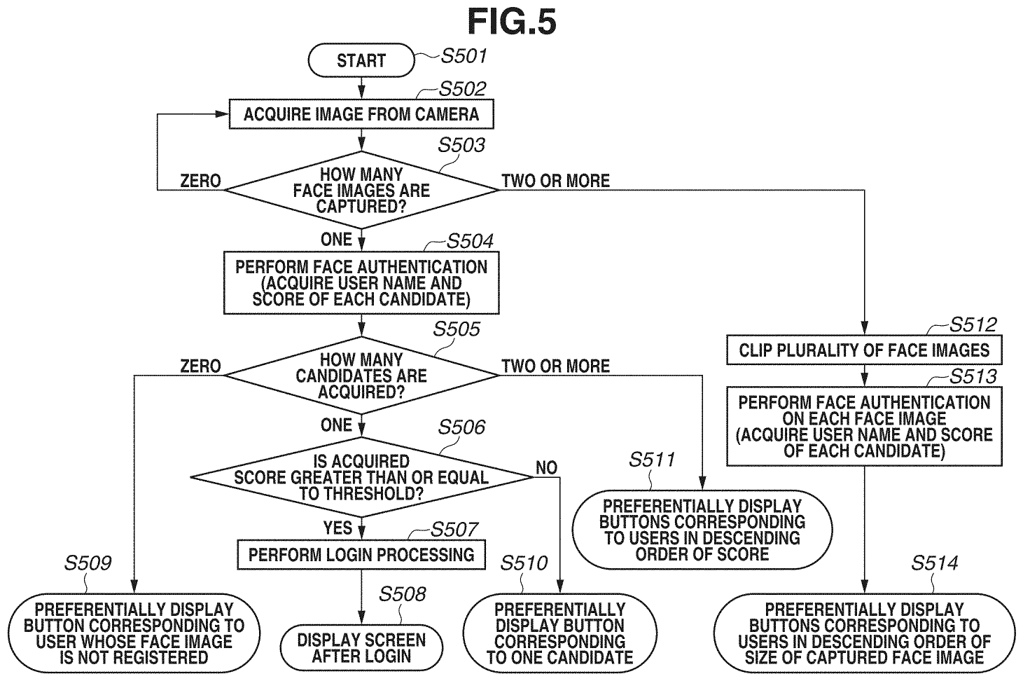

Next, an operation to be performed when the login service 303 performs face authentication will be described with reference to a flowchart illustrated in FIG. 5. The present exemplary embodiment describes a configuration in which at least two login functions of the face authentication function and the simple login function are enabled as described above. The login service 303 is executed by the CPU 201 of the MFP 101 controlling the program for the login service 303 that is loaded into the RAM 203.

When the simple login screen 403 is displayed on the local UI 301, in step S501, the login service 303 activates the camera 209 via the camera driver 305 and starts capturing of an image of the user who approaches the MFP 101. In step S502, the login service 303 acquires the captured image from the camera 209 at regular intervals. Next, in step S503, the login service 303 performs face detection processing on the acquired captured image by using the face detection library 306, checks whether a face image is captured, and determines how many face images are captured.

If the number of detected face images is zero (no face image is captured), the processing returns to step S502 to acquire a new captured image. If the number of detected face images is one, the processing proceeds to step S504. In step S504, face authentication processing is performed. Also, in step S504, the acquired captured image and the face authentication request are transmitted to the REST service 310 of the face authentication server 102, and the personal ID, the user name, and the face authentication score of each candidate are acquired as a response to the face authentication request.

Next, in step S505, the login service 303 checks the number of candidates acquired from the face authentication server 102. If the number of acquired candidates is one, the processing proceeds to step S506. In step S506, the login service 303 determines whether the acquired score is greater than or equal to the threshold. The threshold is a value set in the text box 413. The threshold may be a value preliminarily recorded on the ROM 202 of the MFP 101 as the factory default setting value of the MFP 101. If the score is greater than or equal to the threshold (YES in S506), the processing proceeds to step S507. In step S507, one identified candidate is allowed to log in to the MFP 101. In the login processing of step S507, the login service 303 refers to the account information (Table 3) and acquires the role and the e-mail address of the user corresponding to the user name and the personal ID acquired from the face authentication server 102 to generate the login context (Table 4). Next, in step S508, the login service 303 provides a function available for the login user by displaying the menu screen 401 on the screen of the local UI 301 as a screen after login.

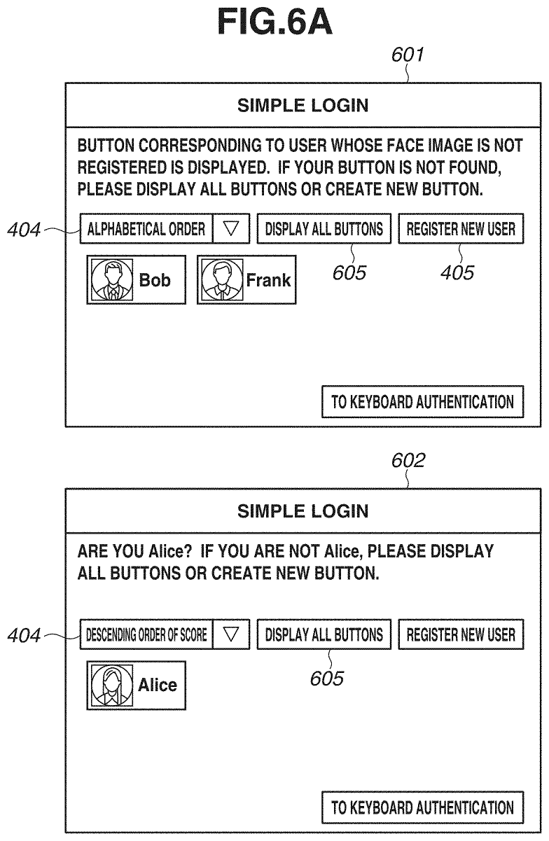

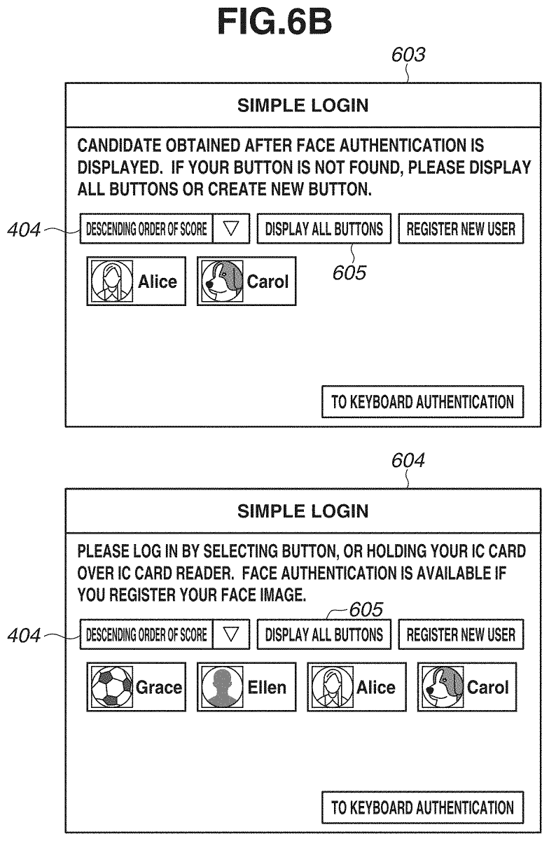

In step S505, if the number of acquired candidates is zero, it can be determined that the user who has approached the MFP 101 is probably a user whose face image is not registered or a user whose account information is not registered. Accordingly, the processing proceeds to step S509. In step S509, the login service 303 customizes the simple login screen 403 so that the button corresponding to the user whose face image is not registered is displayed, and displays the customized simple login screen. FIGS. 6A and 6B illustrate examples of the simple login screen customized after face authentication. For example, if face images of Bob and Frank are not registered, only the buttons corresponding to Bob and Frank are displayed as illustrated in a screen 601. Further, since there is a possibility that the user may be the user whose account information is not registered, the new user registration button 405 can be displayed in a highlighted manner.

If it is determined that the acquired score is smaller than the threshold in step S506 (NO in S506) even when the number of acquired candidates is one in step S505, the processing proceeds to step S510. In step S510, the login service 303 customizes the simple login screen so that the button corresponding to the one candidate is displayed, and displays the customized simple login screen. For example, if the one candidate is Alice, only the button corresponding to Alice is displayed as illustrated in a screen 602. In step S505, if the number of acquired candidates is two or more, the processing proceeds to step S511. In step S511, the buttons corresponding to the candidates having high scores are displayed in descending order of score. For example, if the user names and the scores illustrated in Table 5 to be described below are acquired in step S504, the login service 303 displays the buttons corresponding to Alice and Carol in the descending order of score, i.e., in the order of Alice and Carol, as illustrated in a screen 603. The screen 603 indicates that the user displayed furthest to the left has the highest score, and the other users have lower scores in descending order from the left to the right.

TABLE 5

| User Name | Score |
|---|---|
| Alice | 70 |
| Carol | 15 |

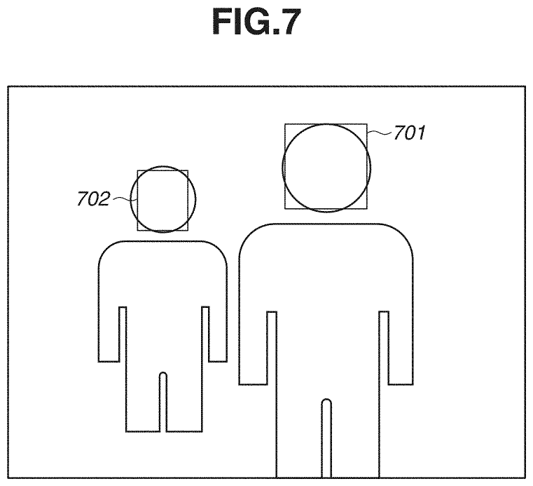

In step S503, if the number of detected face images is two or more, the processing proceeds to step S512. In step S512, a rectangle having edges corresponding to edges of each of the detected face images is clipped. Then, sizes of clipped rectangles are compared. It is determined that the larger rectangle indicates the user located closer to the MFP 101 and the user is likely to be attempting to log in to the MFP 101. For example, rectangles 701 and 702 are clipped from a captured image illustrated in FIG. 7 as a result of face detection. In the captured image illustrated in FIG. 7, the face image indicated by the rectangle 701 is larger than the face image indicated by the rectangle 702. In other words, the user corresponding to the face image with a higher occupied area ratio in the captured image can be regarded as the user who is attempting to log in to the MFP 101.

Next, in step S513, the face image indicated by the rectangle 701 and the face authentication request are transmitted to the REST service 310 of the face authentication server 102, and the personal ID, the user name, and the face authentication score of the candidate are acquired as a response to the face authentication request. Further, the face image indicated by the rectangle 702 and the face authentication request are transmitted to the REST service 310 of the face authentication server 102, and the personal ID, the user name, and the face authentication score of the candidate are acquired as a response to the face authentication request. For example, if user names and scores illustrated in Table 6 are acquired as a result of face authentication performed on the face image indicated by the rectangle 701, and if the login service 303 acquires user names and scores illustrated in Table 7 as a result of face authentication performed on the face image indicated by the rectangle 702 in S514, the login service 303 displays buttons corresponding to the candidates by arranging the buttons in descending order of size of the face image and in descending order of score as illustrated in a screen 604. While Alice has the highest score in an example described below, the buttons are displayed in the order of Grace, Ellen, Alice, and Carol since the size of the face image is prioritized over the score. More specifically, a first display order is determined based on a rectangular area of each of a plurality of face images, and then a second display order is determined based on the score of each of the face images.

TABLE 6

| User Name | Score |
|---|---|
| Grace | 60 |
| Ellen | 10 |

TABLE 7

| User Name | Score |
|---|---|
| Alice | 70 |
| Carol | 15 |

The simple login screens (601, 602, 603, and 604) are provided to the user who has failed in logging in using the face authentication function, and the user is prompted to press a button to log in to the MFP 101. Further, in order to prevent false detection, incorrect operation, or spoofing by another person, a screen for inputting a password may be displayed to prompt the user to input the password during login using the face authentication function or during login by pressing the button of the simple login function.

In the case of filtering and displaying only the buttons to be displayed as illustrated in the screens 601, 602, 603, and 604, the button corresponding to the user whose account information is registered may not be displayed in some cases due to, for example, false detection in the face authentication. For this reason, a button 605 for displaying all the buttons is displayed on the simple login screen.

In addition, in the case of filtering and displaying only the buttons corresponding to the candidates to be displayed, a large number of buttons can be displayed in some cases. Thus, the dropdown 404 for a button sorting function is provided. The buttons can be sorted not only in descending order of score, but also in alphabetical order, in descending order of registration, in descending order of last login time, and the like. More specifically, while the buttons corresponding to the users are sorted in the descending order of score by the processing illustrated in FIG. 5, the user can change the sorting order to arbitrarily order.

Instead of displaying only the buttons to be displayed, all the buttons may be displayed all the time. In this case, the buttons to be displayed can be displayed in order from the top, and other buttons not to be displayed can be arranged in alphabetical order and displayed over a plurality of pages.

As described above, the image forming apparatus according to the exemplary embodiment of the disclosure limits the conditions for allowing a user to log in using the face authentication function based on the number of candidates and the score, thereby reducing the security risk of a different user automatically logging in. Further, even when the user cannot log in using the face authentication function, buttons corresponding to candidates who are more likely to be the user are displayed as illustrated in the screens 601, 602, 603, and 604. Consequently, the user-friendliness is enhanced compared with the simple login screen that does not use the face authentication.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-102880, filed May 31, 2019, which is hereby incorporated by reference herein in its entirety.

What is claimed is:

1. An apparatus that provides a face authentication login function and a simple login function, the face authentication login function allowing a user identified by face authentication based on face data acquired by capturing an image of the user with a camera to log in to the apparatus, the simple login function allowing the user identified based on a button selected from among buttons corresponding to a plurality of users displayed on a login screen to log in to the apparatus, the apparatus comprising:
a setting unit configured to receive a setting for enabling at least two login functions of the face authentication login function and the simple login function,
wherein, in a case where the at least two login functions of the face authentication login function and the simple login function are enabled in the apparatus, the apparatus performs login processing based on a face authentication result indicating that a condition for allowing the user to log in to the apparatus is satisfied and displays a screen after login, and the apparatus displays a button corresponding to each of one or more candidates obtained from the face authentication result on the login screen based on the face authentication result indicating that the condition for allowing the user to log in to the apparatus is not satisfied, performs the login processing upon selection of a button, and displays the screen after login.

2. The apparatus according to claim 1, wherein, in a case where a score of face data on one user identified as a result of the face authentication is smaller than a threshold, a button corresponding to the user obtained from the result of the face authentication is displayed as a candidate button on the login screen.

3. The apparatus according to claim 1, wherein, in a case where two or more users are identified from face data on one person as a result of the face authentication, buttons corresponding to candidates are displayed on the login screen in descending order of score based on scores of the two or more users obtained from the result of the face authentication.

4. The apparatus according to claim 1, wherein, in a case where no use is identified as a candidate as a result of the face authentication, a button corresponding to a user whose face data is not registered is displayed as a candidate button on the login screen.

5. The apparatus according to claim 1, wherein, in a case where data captured with the camera includes pieces of face data on two or more persons, face authentication is performed on each of the pieces of face data on the two or more persons, and buttons corresponding to candidates are displayed on the login screen in descending order of occupied area ratio of the pieces of face data in the data.

6. The apparatus according to claim 5, wherein, in a case where two or more users are identified from face data on one person when the buttons corresponding to the candidates are arranged in the descending order of occupied area ratio of the pieces of face data in the data, the buttons corresponding to the candidates are displayed on the login screen in the descending order of score based on scores of the two or more users obtained from a result of the face authentication, and the buttons corresponding to the candidates are displayed on the login screen in the descending order of occupied area ratio.

7. The apparatus according to claim 1, wherein the setting unit receives, as a setting of an effective login function, a login function selected by the user on a setting screen for selecting a login function.

8. The apparatus according to claim 1, wherein, in a case where the button corresponding to each of the one or more candidates is displayed on the login screen, a button corresponding to another user who is not selected as a candidate is not displayed on the login screen.

9. A method for controlling an apparatus that provides a face authentication login function and a simple login function, the face authentication login function allowing a user identified by face authentication based on face data acquired by capturing an image of the user with a camera to log in to the apparatus, the simple login function allowing the user identified based on a button selected from among buttons corresponding to a plurality of users displayed on a login screen to log in to the apparatus, the method comprising:
receiving a setting for enabling at least two login functions of the face authentication login function and the simple login function,
wherein, in a case where the at least two login functions of the face authentication login function and the simple login function are enabled in the apparatus, the apparatus performs login processing based on a face authentication result indicating that a condition for allowing the user to log in to the apparatus is satisfied and displays a screen after login, and the apparatus displays a button corresponding to each of one or more candidates obtained from the face authentication result on the login screen based on the face authentication result indicating that the condition for allowing the user to log in to the apparatus is not satisfied, performs the login processing upon selection of a button, and displays the screen after login.

10. The method according to claim 9, wherein, in a case where a score of face data on one user identified as a result of the face authentication is smaller than a threshold, a button corresponding to the user obtained from the result of the face authentication is displayed as a candidate button on the login screen.

11. The method according to claim 9, wherein, in a case where two or more users are identified from face data on one person as a result of the face authentication, buttons corresponding to candidates are displayed on the login screen in descending order of score based on scores of the two or more users obtained from the result of the face authentication.

12. The method according to claim 9, wherein, in a case where no use is identified as a candidate as a result of the face authentication, a button corresponding to a user whose face data is not registered is displayed as a candidate button on the login screen.

13. The method according to claim 9, wherein, in a case where data captured with the camera includes pieces of face data on two or more persons, face authentication is performed on each of the pieces of face data on the two or more persons, and buttons corresponding to candidates are displayed on the login screen in descending order of occupied area ratio of the pieces of face data in the data.

14. The method according to claim 9, wherein the receiving the setting receives, as a setting of an effective login function, a login function selected by the user on a setting screen for selecting a login function.

15. A non-transitory computer-readable storage medium that stores a program for performing a method for controlling an apparatus that provides a face authentication login function and a simple login function, the face authentication login function allowing a user identified by face authentication based on face data acquired by capturing an image of the user with a camera to log in to the apparatus, the simple login function allowing the user identified based on a button selected from among buttons corresponding to a plurality of users displayed on a login screen to log in to the apparatus, the method comprising:
receiving a setting for enabling at least two login functions of the face authentication login function and the simple login function,
wherein, in a case where the at least two login functions of the face authentication login function and the simple login function are enabled in the apparatus, the apparatus performs login processing based on a face authentication result indicating that a condition for allowing the user to log in to the apparatus is satisfied and displays a screen after login, and the apparatus displays a button corresponding to each of one or more candidates obtained from the face authentication result on the login screen based on the face authentication result indicating that the condition for allowing the user to log in to the apparatus is not satisfied, performs the login processing upon selection of a button, and displays the screen after login.

16. The non-transitory computer-readable storage medium according to claim 15, wherein, in a case where a score of face data on one user identified as a result of the face authentication is smaller than a threshold, a button corresponding to the user obtained from the result of the face authentication is displayed as a candidate button on the login screen.

17. The non-transitory computer-readable storage medium according to claim 15, wherein, in a case where two or more users are identified from face data on one person as a result of the face authentication, buttons corresponding to candidates are displayed on the login screen in descending order of score based on scores of the two or more users obtained from the result of the face authentication.

18. The non-transitory computer-readable storage medium according to claim 15, wherein, in a case where no use is identified as a candidate as a result of the face authentication, a button corresponding to a user whose face data is not registered is displayed as a candidate button on the login screen.

19. The non-transitory computer-readable storage medium according to claim 15, wherein, in a case where data captured with the camera includes pieces of face data on two or more persons, face authentication is performed on each of the pieces of face data on the two or more persons, and buttons corresponding to candidates are displayed on the login screen in descending order of occupied area ratio of the pieces of face data in the data.

20. The non-transitory computer-readable storage medium according to claim 15, wherein the receiving the setting receives, as a setting of an effective login function, a login function selected by the user on a setting screen for selecting a login function.
